(19) United States
(12) Patent Application Publication
(10) Pub. No.: US 2017/0083444 A1
(43) Pub. Date: Mar. 23, 2017

(54) CONFIGURING FAST MEMORY AS CACHE FOR SLOW MEMORY

(71) Applicant: Advanced Micro Devices, Inc., Sunnyvale, CA (US)

(72) Inventors: Kapil Dev, Austin, TX (US); Mitesh R. Meswani, Austin, TX (US); David A. Roberts, Sunnyvale, CA (US); Yasuko Eckert, Bellevue, WA (US); Indrani Paul, Austin, TX (US); John Kalamatianos, Boxborough, MA (US)

(21) Appl. No.: 14/862,030

(22) Filed: Sep. 22, 2015

(51) Int. Cl. G06F 12/08; G06F 12/10; G06F 12/12

(52) U.S. Cl. CPC G06F 12/0871; G06F 12/0804; G06F 12/0882; G06F 12/121; G06F 12/1054; G06F 2212/69; G06F 2212/608; G06F 2212/68; G06F 2212/1024

(57) ABSTRACT

A cache controller to configure a portion of a first memory as cache for a second memory responsive to an indicator of locality of memory access requests to the second memory. The indicator of locality determines a probability that a location of a memory access request to the second memory is predictable based upon at least one previous memory access request. The cache controller may determine a size of the cache based on a value of the indicator of locality or modify the size of the cache in response to changes in the value of the indicator of locality.

### BACKGROUND

Field of the Disclosure

The present disclosure relates generally to processing systems and, more particularly, to memory access in processing systems.

Description of the Related Art

Processing systems typically include multiple processor cores that execute instructions in parallel with each other. For example, multiple processor cores can concurrently load data or instructions from a memory module such as a random access memory (RAM), execute the instructions, and store the resulting data in the RAM. Heterogeneous memory systems can be used to balance competing demands for high memory capacity, low latency memory access, high bandwidth, and low cost in processing systems ranging from mobile devices to cloud servers. A heterogeneous memory system includes multiple memory modules that operate according to different memory access protocols. The memory modules share the same physical address space, which may be mapped to a corresponding virtual address range, so that the different memory modules are transparent to the operating system of the device that includes the heterogeneous memory system. For example, a heterogeneous memory system may include relatively fast (but high-cost) stacked dynamic RAM (DRAM) and relatively slow (but lower-cost) nonvolatile RAM (NVRAM) that are mapped to a single virtual address range. The latency of memory access requests to the memory modules can be reduced using one or more caches to store copies of data or instructions stored in the memory modules. However, the amount of cache in the processing system is limited by the relatively high cost and low reliability of high speed cache memory.

### BRIEF DESCRIPTION OF THE DRAWINGS

The present disclosure may be better understood, and its numerous features and advantages made apparent to those skilled in the art by referencing the accompanying drawings. The use of the same reference symbols in different drawings indicates similar or identical items.

FIG. 1 is a block diagram of a processing system according to some embodiments.

FIG. 2 is a block diagram of a memory control subsystem according to some embodiments.

FIG. 3 is a block diagram of a first memory module and a second memory module that includes a portion allocated as cache for the first memory module according to some embodiments.

FIG. 4 is a flow diagram of a method of determining a size of a cache that is configured in a first memory module to cache information from a second memory module according to some embodiments.

FIG. 5 is a plot of a curve representing values of a locality indicator as a function of time according to some embodiments.

FIG. 6 is a flow diagram of a method for configuring a portion of a first memory module as cache for a second memory module according to some embodiments.

FIG. 7 is a flow diagram of a method for accessing a cache in a first memory module in response to memory access requests to address ranges in a second memory module according to some embodiments.

### DETAILED DESCRIPTION

The performance of a processing system may be improved by dynamically allocating a portion of a relatively fast memory module in a heterogeneous memory system as cache memory for a portion of a relatively slow memory module in the heterogeneous memory system. A cache controller, operating system, or other address tracking logic detects locality in memory requests to the heterogeneous memory system. As used herein, the phrase “locality” refers to a likelihood or probability that a location accessed by a memory request can be predicted based upon one or more previous memory requests. Temporal locality refers to the reuse of specific data or resources within a predetermined time interval. For example, memory access requests exhibit a high degree of temporal locality if data from the same memory location is accessed repeatedly over a relatively short time interval. The location of subsequent memory access requests therefore has a high probability of being in the repeatedly accessed memory location. Spatial locality refers to the use of data elements within relatively close storage locations, e.g., data elements within the same page or block of pages. Memory requests therefore have a high probability of being located within the same page or block of pages if they have high spatial locality. Sequential locality, a special case of spatial locality, occurs when data elements are arranged and accessed linearly, such as by traversing the elements in a one-dimensional array. Once a memory request has accessed a data element in the one-dimensional array, subsequent memory requests have a high probability of accessing the next element in the one-dimensional array if they have high sequential locality. Memory requests may also exhibit branch locality that indicates a predictable set of outcomes of a branch instruction or equidistant locality in which memory locations are accessed in an equidistant pattern. Some embodiments of the cache controller determine the size of the portion of the relatively fast memory module that is allocated to the cache memory based on a level of detected locality. The size of the cache can change dynamically in response to changes in the locality of the memory requests. In some embodiments, the cache may include more than one logical cache configured to cover different regions of the memory or different types of memories that have different access behavior.

The cache controller may also configure a table that stores information associating a physical address range in the relatively fast memory module that defines the cache to a physical address range corresponding to the portion of the relatively slow memory module that includes information that may be copied to the cache. Some embodiments of the table include information indicating the parameters of the cache, such as a starting physical address of the cache, the number of sets or ways in the cache, a size of the tags for the cache lines, a line size, a replacement policy, error correcting code, and the like. Some embodiments of the cache controller are responsible for ensuring that the physical address space allocated to the cache is free and excluded from the physical address space available for allocation to virtual memory pages by the operating system. The operating system may also enforce excluded memory regions by not mapping them in the page tables. Some embodiments of the cache controller, operating system, or other software may therefore move data from the physical address space allocated to the cache, as well as invalidating and reconfiguring page table entries or translation lookaside buffer entries to reflect the cache allocation.

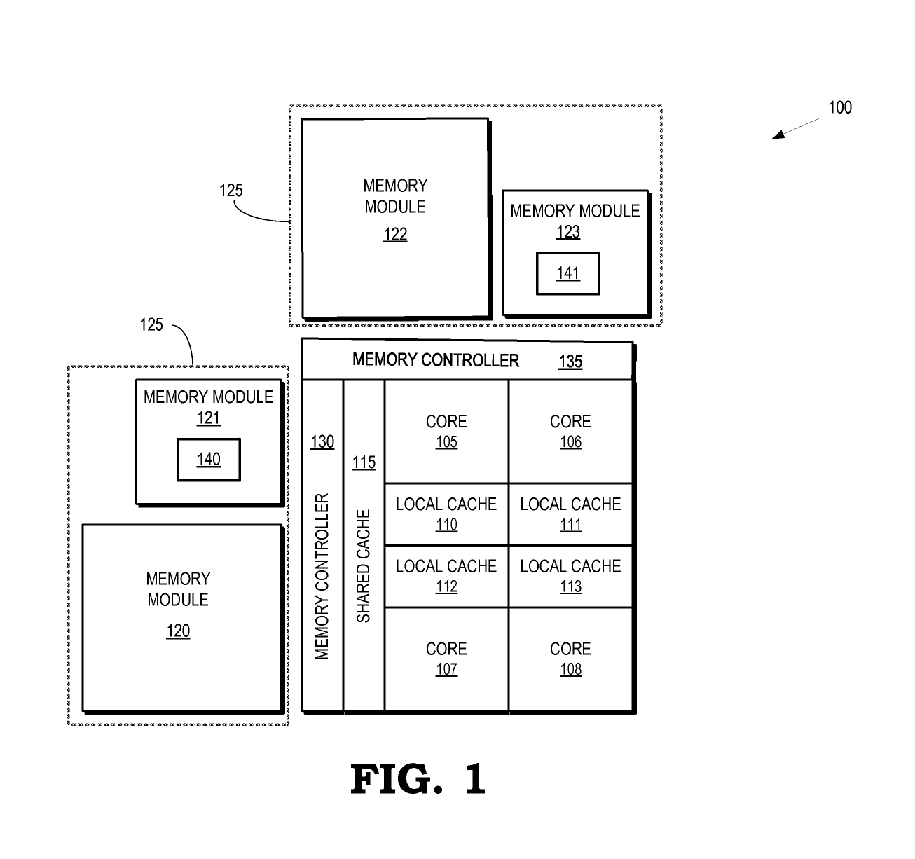

FIG. 1 is a block diagram of a processing system 100 according to some embodiments. The processing system 100 includes multiple processor cores 105, 106, 107, 108 that are referred to collectively as the “processor cores 105-108.” The processor cores 105-108 can execute instructions independently, concurrently, or in parallel. The processing system 100 shown in FIG. 1 includes four processor cores 105-108. However, some embodiments of the processing system 100 may include more or fewer than the four processor cores 105-108 shown in FIG. 1. Some embodiments of the processing system 100 may be formed on a single substrate, e.g., as a system-on-a-chip (SOC). The processing system 100 may be used to implement a central processing unit (CPU), a graphics processing unit (GPU), an accelerated processing unit (APU) that integrates CPU and GPU functionality in a single chip, a field programmable gate array (FPGA), an application specific integrated circuit (ASIC), and the like.

The processing system 100 implements caching of data and instructions, and some embodiments of the processing system 100 may therefore implement a hierarchical cache system. Some embodiments of the processing system 100 include local caches 110, 111, 112, 113 that are referred to collectively as the “local caches 110-113.” However, other embodiments of the processing system 100 may include more or fewer caches. Each of the processor cores 105-108 is associated with a corresponding one of the local caches 110-113. For example, the local caches 110-113 may be L1 caches for caching instructions or data that may be accessed by one or more of the processor cores 105-108. Some embodiments of the local caches 110-113 may be subdivided into an instruction cache and a data cache. The processing system 100 also includes a shared cache 115 that is shared by the processor cores 105-108 and the local caches 110-113. The shared cache 115 may be referred to as a last level cache (LLC) if it is the highest level cache in the cache hierarchy implemented by the processing system 100. Some embodiments of the shared cache 115 are implemented as an L2 cache. The cache hierarchy implemented by the processing system 100 is not limited to the two level cache hierarchy shown in FIG. 1. Some embodiments of the hierarchical cache system include additional cache levels such as an L3 cache, an L4 cache, or other cache depending on the number of levels in the cache hierarchy.

The processing system 100 also includes a plurality of memory modules 120, 121, 122, 123, which may be referred to collectively as “the memory modules 120-123.” Although four memory modules 120-123 are shown in FIG. 1, some embodiments of the processing system 100 may include more or fewer memory modules 120-123. The memory modules 120-123 may be implemented as different types of RAM. Some embodiments of the memory modules 120-123 are used to implement a heterogeneous memory system 125. For example, the plurality of memory modules 120-123 can share a physical address space associated with the heterogeneous memory system 125 so that memory locations in the memory modules 120-123 are accessed using a continuous set of physical addresses. The memory modules 120-123 may therefore be transparent to the operating system of the processing system 100, e.g., the operating system may be unaware that the heterogeneous memory system 125 is made up of more than one memory module 120-123. In some embodiments, the physical address space of the heterogeneous memory system 125 may be mapped to one or more virtual address spaces.

The memory modules 120-123 may operate according to different memory access protocols. For example, the memory modules 120, 122 may be nonvolatile RAM (NVRAM) that operate according to a first memory access protocol and the memory modules 121, 123 may be dynamic RAM (DRAM) that operate according to a second memory access protocol that is different than the first memory access protocol. Examples of memory access protocols include double data rate (DDR) access protocols including DDR3 and DDR4, phase change memory (PCM) access protocols, flash memory access protocols, and the like. Memory requests to the memory modules 120, 122 are therefore provided in a different format than memory requests to the memory modules 121, 123. Some embodiments of the memory modules 120-123 are implemented as stacked memory that includes memory elements formed on more than one die or layer. The dies or layers are then stacked on top of each other and interconnected using interconnect structures such as wires, traces, pins, balls, pads, interposers, and the like. Stacked memory modules 120-123 may be deployed on or adjacent to other portions of the processing system 100 such as a die that includes the processor cores 105-108, the local caches 110-113, the shared cache 115, and the memory controllers 130, 135.

The memory modules 120-123 may also have different memory access characteristics. For example, the length of the memory rows in the memory modules 120, 122 may differ from the length of the memory rows in the memory modules 121, 123. The memory modules 120-123 may include row buffers that hold information fetched from rows within the memory modules 120-123 before providing the information to the processor cores 105-108, the local caches 110-113, or the shared cache 115. The sizes of the row buffers may differ due to the differences in the length of the memory rows in the memory modules 120-123. The memory modules 120-123 may also have different levels of memory request concurrency, different bandwidths, different loads, and the like. In the illustrated embodiment, the memory modules 120, 122 are “slower” than the memory modules 121, 123. For example, the memory modules 120, 122 may be implemented as NVRAM that have longer memory access latencies than the memory modules 121, 123, which may be implemented as stacked DRAM.

Memory controllers 130, 135 are used to control access to the memory modules 120-123. For example, the memory controllers 130, 135 can receive memory access requests (such as read requests and write requests) from a last-level cache such as the shared cache 115 and then selectively provide the memory access requests to the memory access modules 120-123 based on physical addresses indicated in the requests. The memory controllers 130, 135 may also configure portions 140, 141 of the memory modules 121, 123 to act as cache for the memory modules 120, 122. Some embodiments of the memory controllers 130, 135 include cache controllers (not shown in FIG. 1) to configure the portions 140, 141 as cache for the corresponding memory modules 120, 122 responsive to an indicator of locality of memory access requests to the memory modules 120, 122. The indicator of locality may include indicators of temporal locality, spatial locality, branch locality, equidistant locality, statistical combinations of locality indicators, or other locality indicators. The cache controller may determine a size of the portions 140, 141 that are configured as cache responsive to a value of the indicator of locality. The cache controller may also modify the size of the portions 140, 141 in response to changes in the value of the indicator of locality.

Some embodiments of the processing system 100 include additional memory modules that are configured to implement additional levels of memory to form an n-level memory hierarchy. For example, the processing system 100 can implement a 3-level memory hierarchy using the memory modules 120-123 or additional memory modules that are a part of the memory hierarchy of the processing system 100. The memory controllers 130, 135 can configure portions of each of the levels in the memory hierarchy (such as portions 140, 141 of the memory modules 121, 123) to act as cache for any of the lower-level memory module such as the memory modules 120, 122. For example, in a 3-level memory hierarchy, a portion of the highest level (first level) memory module may be configured as cache for the next lower-level (second level) memory module, the lowest level (third level) memory module, or both. As used herein, the relative terms “higher level,” “lower level,” and the like refer to differences in characteristics such as memory access latency or memory access bandwidth. For example, higher level memory modules have lower memory access latencies or higher memory access bandwidth. On-chip memory modules may also be used as cache for off-chip or off-package memory modules. Memory modules that are persistent during power failures (such as NVRAM) may be used as cache for volatile memory.

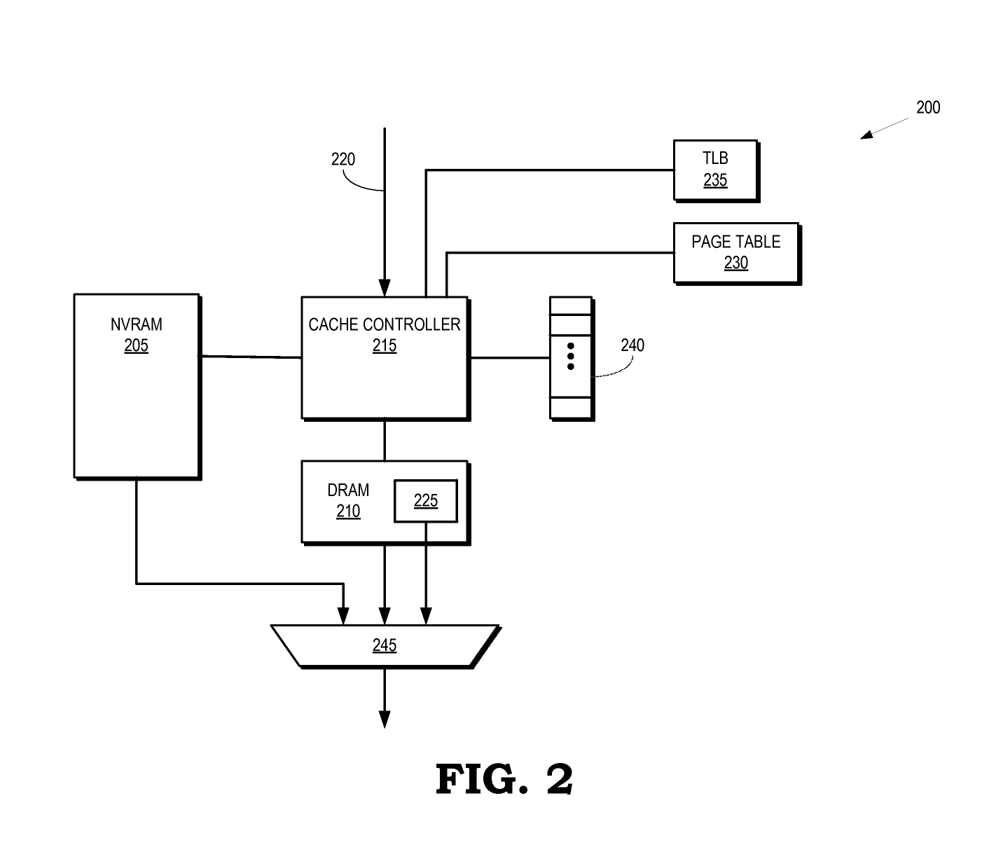

FIG. 2 is a block diagram of a memory control subsystem 200 according to some embodiments. The memory control subsystem 200 may be implemented in some embodiments of the processing system 100 shown in FIG. 1. The memory control subsystem 200 includes a first memory module that is implemented as NVRAM 205 and a second memory module that is implemented as DRAM 210. The NVRAM 205 and the DRAM 210 may be used to implement some embodiments of the memory modules 120-123 shown in FIG. 1.

A cache controller 215 issues memory access requests to the NVRAM 205 or the DRAM 210 in response to receiving memory access requests 220, such as a request from a last level cache. The cache controller 215 also configures a portion 225 of the DRAM 210 as cache for the NVRAM 205 responsive to an indicator of locality in the memory access requests 220 that are received by the cache controller 215. As discussed herein, configuring the portion 225 as cache may include removing the portion 225 from the address space of the DRAM 210, moving data stored in pages that overlap the portion 225, modifying entries in a page table 230 or a translation lookaside buffer (TLB) 235, flushing data from the cache, and the like.

The memory control subsystem 200 includes a table 240, which may be implemented using registers or other memory elements. The table 240 includes values of parameters and other information that is used to configure the portion 225 to cache information from the NVRAM 205. Some embodiments of the table 240 include information indicating a region in the NVRAM 205 that includes information that is eligible to be cached in the portion 225. For example, the region may be defined by an address range or ranges within the NVRAM 205. The table 240 may also include information indicating a start address (within the portion 225) of the logical cache associated with the region of the NVRAM 205. In some embodiments, the portion 225 may include more than one logical cache that is associated with more than one region within the NVRAM 205. The table 240 may therefore include multiple entries associated with the different logical caches. The table 240 may also include parameters of the one or more logical caches including the number of sets or ways in the cache, a tag size, a line size for lines in the cache, a replacement policy such as a least-recently-used cache replacement policy, error correcting code that is used to identify and correct errors in the cached information, and the like.

Some embodiments of the cache controller 215 configure the one or more caches in a portion 225 that is defined by a contiguous physical address range within the DRAM 210, thereby avoiding complex re-mapping of the physical address range. The cache controller 215 exposes the contiguous physical address range to the operating system so that the operating system does not allocate pages in the portion 225.

Cache lines in the cache are used to store information retrieved from the NVRAM 205. The cache controller 215 uses tags associated with the cache lines to determine when a memory access request hits a cache line in the cache. Some embodiments of the cache controller 215 may select the number of bits in the tag for each cache line responsive to the size of the cache or the size of the address region of the NVRAM 205 that is being cached. The cache lines may be associated with cache line state bits such as valid bits to indicate whether the data in the cache line is valid, dirty bits to indicate whether the data has been changed since the last write back to the NVRAM 205, and the like. The cache controller 215 can initialize the newly established or modified cache by setting the cache line state bits to values that indicate that the data in the cache line is invalid and clean.

A multiplexer 245 is used to selectively provide information from the NVRAM 205, the DRAM 210, or the cache in the portion 225 in response to the memory access requests 220. For example, the cache controller 215 compares the memory address in the memory access request 220 to ranges of memory addresses of the NVRAM 205 that are stored in the table 240. If the memory address is in one of the address ranges associated with a logical cache in the portion 225, the cache controller 215 uses the memory address in the memory access request 220 to determine whether the requested information is stored in the cache using the tags in the cache. If the memory request hits in the cache, the requested information is provided from the cache to the multiplexer 245, which provides the information. If the memory request misses in the cache, the cache controller 215 provides the memory access request to the NVRAM 205, which may provide the requested information to the multiplexer 245. The cache controller 215 may also send memory requests to the DRAM 210 if the memory address is within an address range of the DRAM 210. The DRAM 210 may then provide the requested information to the multiplexer 245.

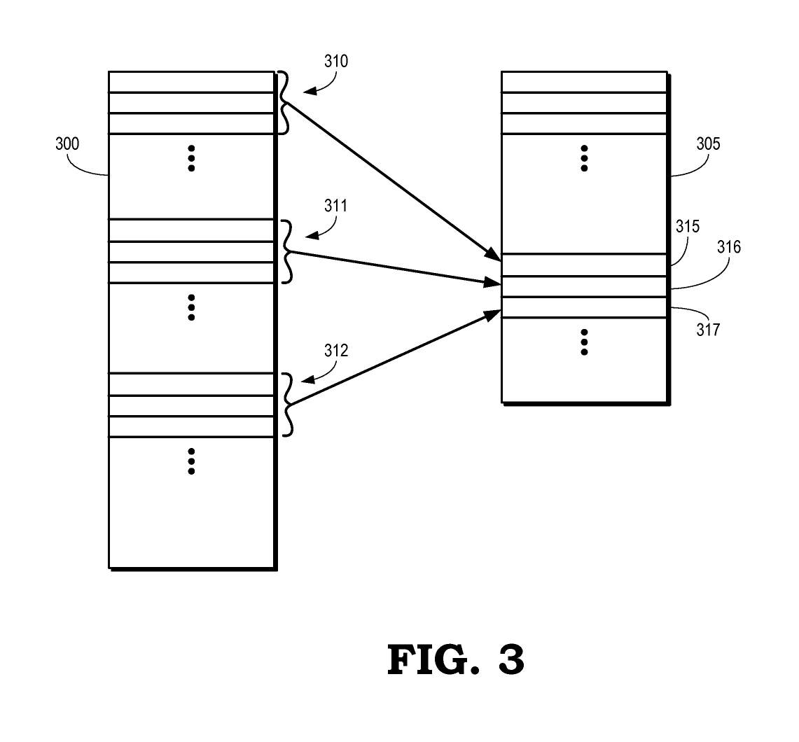

FIG. 3 is a block diagram of a first memory module 300 and a second memory module 305 that includes a portion allocated as cache for the first memory module 300 according to some embodiments. The first memory module 300 and the second memory module 305 may be used to implement some embodiments of the memory modules 120-123 shown in FIG. 1. Memory elements (such as rows, pages, or blocks of pages) in the region 310 of the first memory module 300 can be cached in a portion 315 of the second memory module 305. Memory elements in the region 311 of the first memory module 300 can be cached in a portion 316 of the second memory module 305. Memory elements in the region 312 of the first memory module 300 can be cached in a portion 317 of the second memory module 305. The regions 310-312 and the portions 315-317 may be indicated by corresponding physical address ranges.

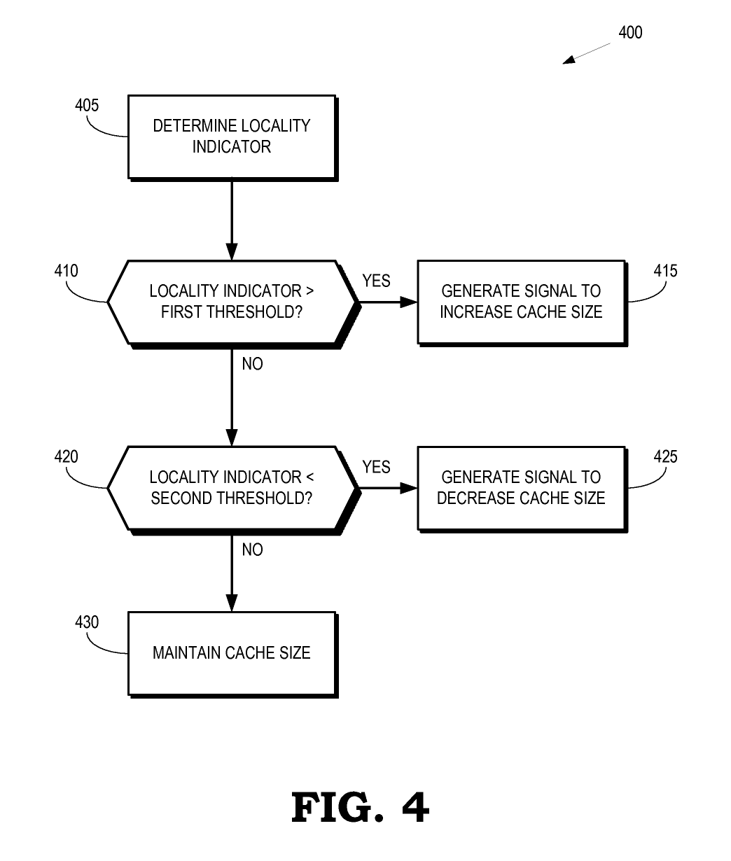

FIG. 4 is a flow diagram of a method 400 of determining a size of a cache that is configured in a first memory module to cache information from a second memory module according to some embodiments. The method 400 may be implemented in some embodiments of the processing system 100 shown in FIG. 1 or the memory control subsystem 200 shown in FIG. 2.

At block 405, a cache controller determines a locality indicator based upon one or more memory access requests that include addresses in an address range of the second memory. The locality indicator may be an indicator of spatial locality, temporal locality, instruction locality, equidistant locality, and the like. Some embodiments of the cache controller may generate the locality indicator based on the memory requests received at the cache controller or information received from other entities in the processing system. The locality indicator may have a relatively high value (indicating a high degree of instruction locality) if the set of instruction pages accessed in the second memory is repetitive. The size of this set can be used for proper cache sizing. For another example, applications (or particular phases of an application) may repeatedly reuse a fixed set of pages. The cache controller may therefore determine that the application or application phase has a high degree of spatial locality or temporal locality. In some embodiments, an API may be used to allow software to pass information to the cache controller to indicate spatial or temporal reuse. The API may also tag (or otherwise identify) a set of pages that can be cached or indicate a footprint for proper cache sizing. The cache controller can use this information to configure and populate the cache.

At decision block 410, the cache controller compares the locality indicator to a first threshold. If the locality indicator is greater than the first threshold, the cache controller may generate a signal to increase the cache size at block 415. The signal may then be used to initiate reconfiguration of the cache and other entities in the processing system to support the larger cache size, as discussed herein. If the locality indicator is lower than the first threshold, the method 400 flows to decision block 420.

At decision block 420, the cache controller compares the locality indicator to a second threshold. If the locality indicator is less than the second threshold, the cache controller may generate a signal to decrease the cache size at block 425. The signal may then be used to initiate reconfiguration of the cache and other entities in the processing system to support the smaller cache size, as discussed herein. If the locality indicator is greater than the second threshold, the cache controller maintains the size of the cache at block 430. The first threshold and the second threshold may have the same value or the second threshold can be set to a value that is lower than the first threshold to provide a hysteresis.

In some embodiments of the method 400 shown in FIG. 4, the write endurance property of the second memory can be used to determine a cache configuration, either in addition to or instead of using the locality indicator. For example, if a hardware or software profiler detects a set of pages that are more frequently written than others, those pages may be cached in the first memory module to reduce the number of writes in the second memory module, thereby increasing the potential write endurance of the second memory module. When other non-cached pages start seeing large write traffic, the pages may be cached, e.g., by increasing the size of the cache in the first memory module. Once the rate of write operations into a cached page goes below a threshold, the page is written back to the second memory module and the cache portion of the first memory module is resized accordingly. In some embodiments, the cache controller may also consider cache reuse frequency and predictive mechanisms to configure the cache ahead of time to improve overall performance. During periods of low cache utilization, the cache controller can configure the cache back to the first memory module or put the cache into low power modes to save power.

The cache controller performs other operations to remove the space used by the cache from the physical address space of the first memory and to coordinate operation of other entities in the processing system. For example, the cache controller may flush a TLB in response to changes in the memory configuration such as configuring a portion of the first memory to act as the cache or changing the cache size. However, flushing the TLB might introduce a performance penalty. In order to avoid or minimize the penalty, some embodiments of the cache controller perform the memory reconfiguration between two sets of jobs that have different page cache requirements instead of during the time when a program is running actively. In high-performance computing (HPC) server systems, workloads are launched in the form of batches. Some embodiments of the cache controller may therefore select the memory configuration (cache versus memory) between two sets of batches. Based on the program's characteristics, the operating system could decide the size of the first memory module to be configured as cache. Further, the workloads on servers may be different at different time of the day. For example, the workload might be lighter during the night time than at the day time; so, the memory reconfiguration could be performed during night time to avoid incurring performance losses.

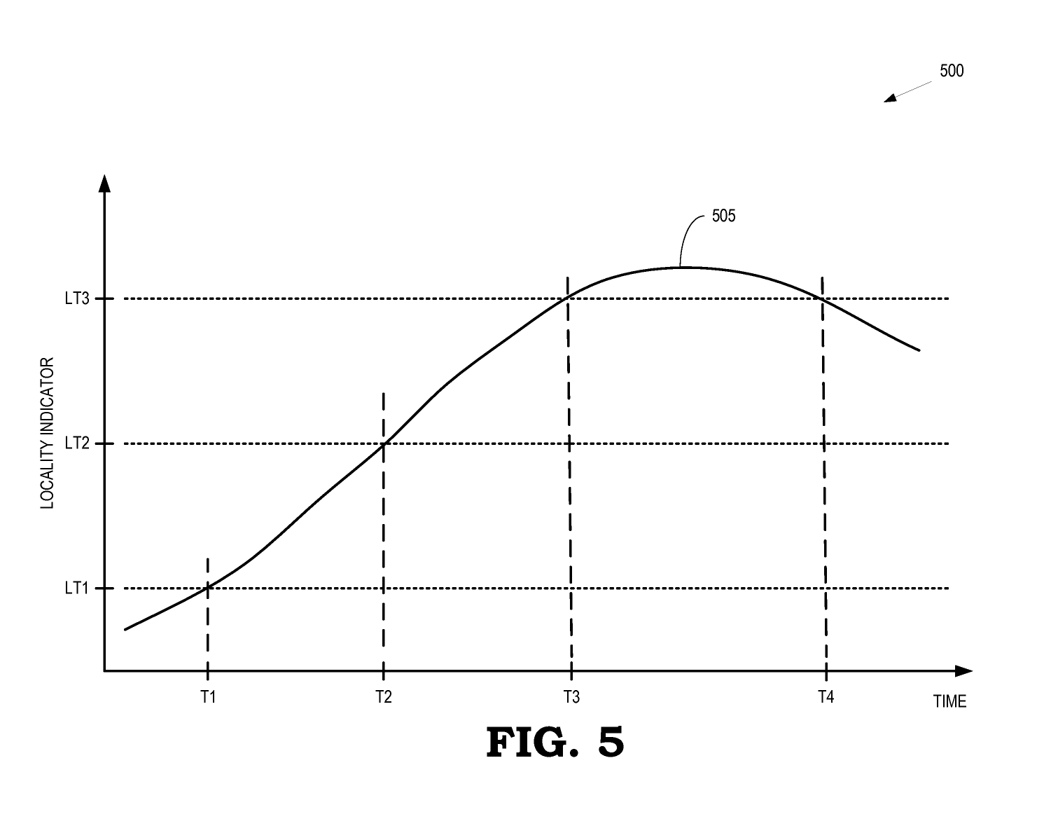

FIG. 5 is a plot 500 of a curve 505 representing values of a locality indicator as a function of time according to some embodiments. The curve 505 may represent values determined by or received by a controller such as the cache controller 215 shown in FIG. 2. The vertical axis indicates the value of the locality indicator in arbitrary units and the horizontal axis indicates time increasing from left to right. Threshold values (LT1, LT2, LT3) are indicated by hash marks on the vertical axis and correspond to values of the locality indicator that indicate different cache sizes for a cache that is implemented in a portion of a first memory module to cache information from a second memory module, as discussed herein. Although three threshold values are indicated in the plot 500, some embodiments may use more or fewer numbers of threshold values or may vary the cache size substantially continuously as a function of a locality indicator. In some embodiments, different threshold values may be used to determine whether to increase or decrease the size of the cache to provide a hysteresis.

At T<T1, the value of the locality indicator is less than the first threshold value, which indicates that none of the first memory module is to be configured as cache because the low value of the locality indicator indicates that minimal performance gains (or even negative performance gains) are likely to result from caching information from the second memory module in the first memory module.

At T1<T<T2, the value of the locality indicator is greater than the first threshold value, which indicates that a portion of the first memory module is to be configured as cache because the increased value of the locality indicator indicates that performance gains are likely to result from caching information from the second memory module in the first memory module. The cache controller may then generate a signal to initiate configuration of the portion of the first memory module as cache and the cache may be configured in response to the signal, as discussed herein.

At T2<T<T3, the value of the locality indicator is greater than the second threshold value, which indicates that the size of the portion of the first memory module that is configured as cache should be increased because the increased value of the locality indicator indicates that additional performance gains are likely to result from increasing the amount of information from the second memory module that can be cached in the first memory module. The cache controller may then generate a signal to increase the size of the portion of the first memory module that is configured as cache and the cache may be reconfigured at the larger size in response to the signal, as discussed herein.

At T3<T<T4, the value of the locality indicator remains greater than the second threshold value and the size of the cache is maintained by the cache controller.

At T>T4, the value of the locality indicator is lower than the second threshold value, which indicates that the size of the portion of the first memory module that is configured as cache should be decreased because the decreased value of the locality indicator indicates that additional performance gains are not likely to result from maintaining the size of the cache at the larger size that was used at T3<T<T4. The cache controller may then generate a signal to decrease the size of the portion of the first memory module that is configured as cache and the cache may be reconfigured at the smaller size in response to the signal, as discussed herein.

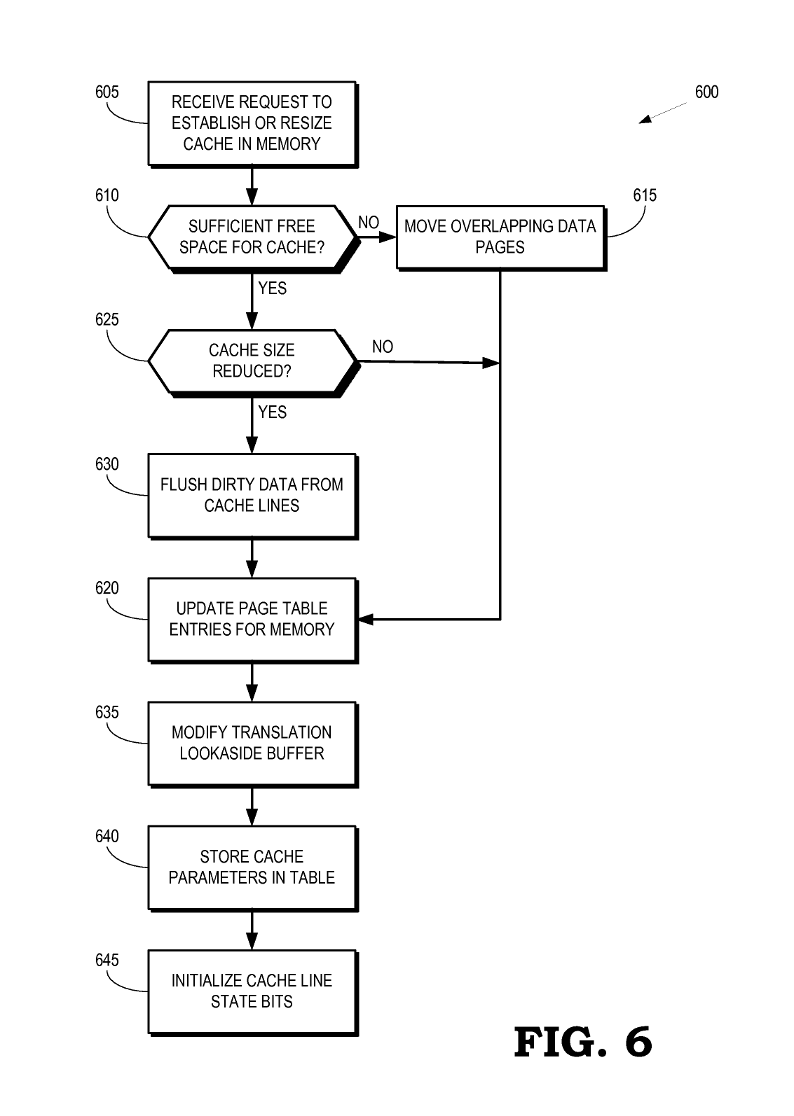

FIG. 6 is a flow diagram of a method 600 for configuring a portion of a first memory module as cache for a second memory module according to some embodiments. The method 600 may be implemented in some embodiments of the processing system 100 shown in FIG. 1 or the memory control subsystem 200 shown in FIG. 2.

At block 605, a request is received to establish or resize a cache in the first memory module. For example, a cache controller or operating system may detect a signal generated to indicate that the cache is to be established or resized, as discussed herein with regard to FIG. 5. Some embodiments of the request include information indicating a requested size of the cache, an address range of the second memory that includes the information that is to be cached, and the like. Some embodiments of the cache controller may allocate contiguous physical address ranges to the one or more logical caches implemented in the first memory module and may inform the operating system of these ranges so that the operating system does not allocate pages into the allocated page ranges. Using contiguous physical address ranges may simplify the design and remove the need for complex remapping of the physical addresses of the logical cache. Some embodiments of the cache controller may also determine the number of bits in tags for the cache lines depending on the size of the cache or the size of the address region in the second memory module that is being cached.

At decision block 610, the operating system (or other entity in the processing system) determines whether there is sufficient free space for the requested cache. For example, the operating system may compare the requested size of the cache to a number of free pages available in the first memory. If not, the operating system moves (at block 615) data in any overlapping pages out of the portion of the first memory that is allocated to the cache and frees the space in the allocated portion of the first memory. For example, the operating system may instruct software implemented in the processing system to move data pages overlapping the allocated portion of the first memory module to other locations in the memory system. Moving pages from the allocated portion triggers updates to entries in a page table such as the page table 230 shown in FIG. 2 and triggers shoot downs to invalidate entries in a TLB such as the TLB 235 shown in FIG. 2 so that changes in a mapping of virtual pages to physical pages are reflected in the modified TLB. The operating system also removes the space allocated to the cache from the physical address space and ensures that virtual pages are not mapped into the space allocated to the cache. The method 600 then flows to block 620. If the operating system determines that there is sufficient free space for the requested cache, the method flows to decision block 625.

At decision block 625, the cache controller or operating system determines whether the received request indicated that the cache size is to be reduced. If not, the method flows to block 620. If the cache size is to be reduced, dirty cache lines (e.g., as indicated by a value of a dirty bit associated with the cache line) are flushed (at block 630) to avoid data loss when the size of the cache is reduced.

At block 620, page table entries for the first memory module are updated to reflect any changes that are caused by configuration or modification of the cache in the first memory module. At block 635, the TLB for the first memory module is modified to reflect any changes that are caused by configuration or modification of the cache in the first memory module. For example, mappings of virtual addresses to physical addresses in the TLB can be modified by invalidating entries in the TLB to reflect the changes in the physical addresses available to the first memory module after the cache has been modified.

At block 640, the cache controller stores parameters that define the cache in a table such as the table 240 shown in FIG. 2. Some embodiments of the table are implemented as registers. The cache controller may then store the parameters by programming the registers to indicate the cache parameters. For example, the cache controller may store information indicating an address range of a portion of the second memory module that is associated with the cache in the first memory module. For another example, the cache controller may store information indicating a starting address (in the first memory module) of the logical cache associated with the address range of the portion of the second memory module. For yet another example, the cache controller may store information indicating parameters of the logical cache such as a number of sets in the logical cache, a number of ways in the logical cache, a tag size, a size of the cache lines, a replacement policy such as a least-recently-used replacement policy, an error correcting code to apply to the cache lines, and the like.

At block 645, the cache controller initializes the newly established cache or the expanded portion of the cache. Initializing the cache may include operations such as setting state bits for the cache lines to a predetermined initial value. For example, the valid bits and dirty bits associated with the cache lines may be set to a value of 0 to indicate that the information cached in the cache lines is not valid and not dirty.

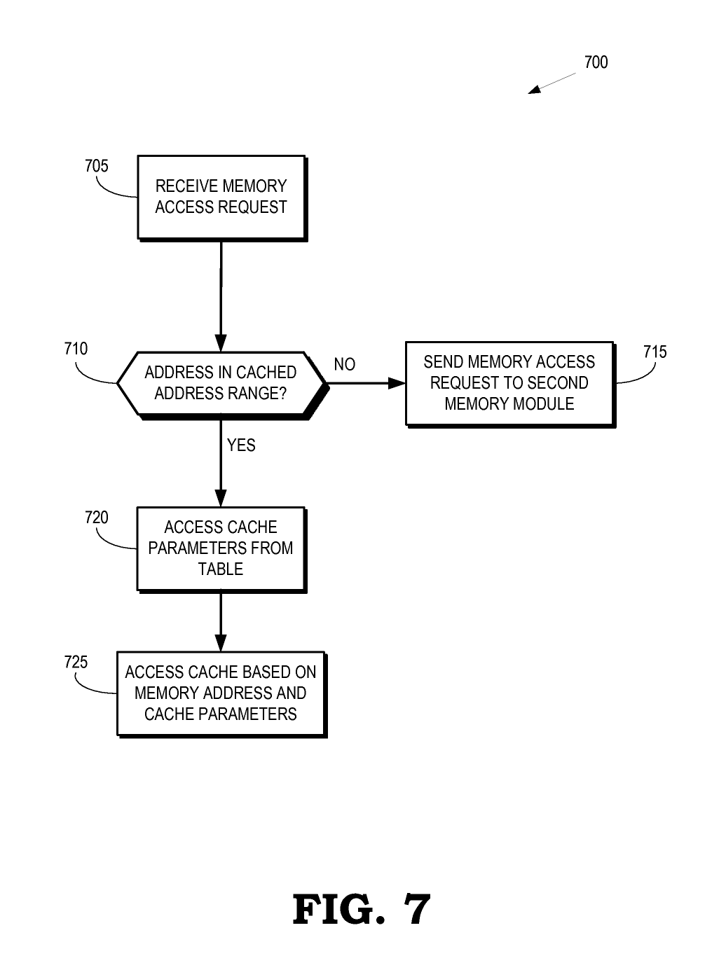

FIG. 7 is a flow diagram of a method 700 for accessing a cache in a first memory module in response to memory access requests to address ranges in a second memory module according to some embodiments. The method 700 may be implemented in some embodiments of the memory controllers 130, 135 shown in FIG. 1 or the cache controller 215 shown in FIG. 2.

At block 705, the controller receives the memory access request, e.g., in response to a cache miss in a last level cache. At decision block 710, the controller determines whether the address in the memory access request is in an address range of the second memory module that corresponds to information that can be cached in the cache of the first memory module. If not, the controller sends the memory request to the second memory module at block 715. If the memory address is in the address range associated with the cache, the method 700 flows to block 720.

At block 720, the controller accesses cache parameters from a table such as the table 240 shown in FIG. 2. As discussed herein, the first memory module may implement multiple logical caches that have different starting physical addresses indicated in the table. The cache controller may therefore access information indicating the starting physical address of the cache associated with the address range of the second memory module that includes the address in the memory access request. The cache controller may also access values of cache parameters such as the cache parameters discussed herein.

At block 725, the controller controls the cache according to the cache parameters accessed from the table. For example, state machines or microcode in the controller can calculate the address of the logical cache line based on the starting physical address of the cache, access status bits such as the valid bit or dirty bit for the cache line, perform tag accesses, perform in-memory cache requests such as line fills or write backs, or perform other cache operations.

In some embodiments, the apparatus and techniques described above are implemented in a system comprising one or more integrated circuit (IC) devices (also referred to as integrated circuit packages or microchips), such as the memory controller or cache controller described above with reference to FIGS. 1-7. Electronic design automation (EDA) and computer aided design (CAD) software tools may be used in the design and fabrication of these IC devices. These design tools typically are represented as one or more software programs. The one or more software programs comprise code executable by a computer system to manipulate the computer system to operate on code representative of circuitry of one or more IC devices so as to perform at least a portion of a process to design or adapt a manufacturing system to fabricate the circuitry. This code can include instructions, data, or a combination of instructions and data. The software instructions representing a design tool or fabrication tool typically are stored in a computer readable storage medium accessible to the computing system. Likewise, the code representative of one or more phases of the design or fabrication of an IC device may be stored in and accessed from the same computer readable storage medium or a different computer readable storage medium.

A computer readable storage medium may include any storage medium, or combination of storage media, accessible by a computer system during use to provide instructions and/or data to the computer system. Such storage media can include, but is not limited to, optical media (e.g., compact disc (CD), digital versatile disc (DVD), Blu-Ray disc), magnetic media (e.g., floppy disc, magnetic tape, or magnetic hard drive), volatile memory (e.g., random access memory (RAM) or cache), non-volatile memory (e.g., read-only memory (ROM) or Flash memory), or microelectromechanical systems (MEMS)-based storage media. The computer readable storage medium may be embedded in the computing system (e.g., system RAM or ROM), fixedly attached to the computing system (e.g., a magnetic hard drive), removably attached to the computing system (e.g., an optical disc or Universal Serial Bus (USB)-based Flash memory), or coupled to the computer system via a wired or wireless network (e.g., network accessible storage (NAS)).

In some embodiments, certain aspects of the techniques described above may implemented by one or more processors of a processing system executing software. The software comprises one or more sets of executable instructions stored or otherwise tangibly embodied on a non-transitory computer readable storage medium. The software can include the instructions and certain data that, when executed by the one or more processors, manipulate the one or more processors to perform one or more aspects of the techniques described above. The non-transitory computer readable storage medium can include, for example, a magnetic or optical disk storage device, solid state storage devices such as Flash memory, a cache, random access memory (RAM) or other non-volatile memory device or devices, and the like. The executable instructions stored on the non-transitory computer readable storage medium may be in source code, assembly language code, object code, or other instruction format that is interpreted or otherwise executable by one or more processors.

Note that not all of the activities or elements described above in the general description are required, that a portion of a specific activity or device may not be required, and that one or more further activities may be performed, or elements included, in addition to those described. Still further, the order in which activities are listed are not necessarily the order in which they are performed. Also, the concepts have been described with reference to specific embodiments. However, one of ordinary skill in the art appreciates that various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure.

Benefits, other advantages, and solutions to problems have been described above with regard to specific embodiments. However, the benefits, advantages, solutions to problems, and any feature(s) that may cause any benefit, advantage, or solution to occur or become more pronounced are not to be construed as a critical, required, or essential feature of any or all the claims. Moreover, the particular embodiments disclosed above are illustrative only, as the disclosed subject matter may be modified and practiced in different but equivalent manners apparent to those skilled in the art having the benefit of the teachings herein. No limitations are intended to the details of construction or design herein shown, other than as described in the claims below. It is therefore evident that the particular embodiments disclosed above may be altered or modified and all such variations are considered within the scope of the disclosed subject matter. Accordingly, the protection sought herein is as set forth in the claims below.

What is claimed is:

1. A method comprising:
configuring a portion of a first memory as cache for a second memory responsive to an indicator of locality of memory access requests to the second memory, wherein the indicator of locality determines a probability that a location of a memory access request to the second memory is predictable based upon at least one previous memory access request.

2. The method of claim 1, further comprising:
determining a size of the cache based on a value of the indicator of locality.

3. The method of claim 2, wherein determining the size of the cache comprises modifying the size of the cache in response to a change in the value of the indicator of locality.

4. The method of claim 3, wherein configuring the portion of the first memory as cache comprises removing the portion of the first memory from a physical address space of the first memory in response to increasing the size of the cache.

5. The method of claim 4, wherein removing the portion of the first memory from the physical address space of the first memory comprises moving at least one data page that overlaps the portion of the first memory and modifying at least one of a page table and a translation lookaside buffer.

6. The method of claim 3, wherein configuring the portion of the first memory as cache comprises flushing at least one dirty line in the cache prior to decreasing the size of the cache and modifying at least one of a page table and a translation lookaside buffer in response to decreasing the size of the cache, wherein the at least one dirty line in the cache includes data that has been changed since a last write back to the second memory.

7. The method of claim 1, wherein configuring the portion of the first memory as cache comprises configuring a table to associate at least one physical address range of the cache in the first memory with at least one physical address range in the second memory that includes information for caching in the cache.

8. The method of claim 7, wherein the table includes at least one parameter to define the cache, the at least one parameter comprising at least one of: information indicating a starting physical address of the cache, a number of sets or ways in the cache, a line size in the cache, a replacement policy for the cache, and an error correcting code for a cache line in the cache.

9. The method of claim 1, wherein configuring the portion of the first memory as cache comprises configuring a plurality of caches associated with a plurality of physical address ranges in the second memory.

10. The method of claim 1, wherein the indicator of locality comprises an indicator of at least one of temporal locality and spatial locality.

11. An apparatus comprising:
a cache controller to configure a portion of a first memory as cache for a second memory responsive to an indicator of locality of memory access requests to the second memory, wherein the indicator of locality determines a probability that a location of a memory access request to the second memory is predictable based upon at least one previous memory access request.

12. The apparatus of claim 11, wherein the cache controller is to determine a size of the cache based on a value of the indicator of locality.

13. The apparatus of claim 12, wherein the cache controller is to modify the size of the cache in response to a change in the value of the indicator of locality.

14. The apparatus of claim 13, wherein the cache controller is to remove the portion of the first memory from a physical address space of the first memory in response to increasing the size of the cache.

15. The apparatus of claim 14, wherein the cache controller is to move at least one data page that overlaps the portion of the first memory configured as the cache and modify at least one of a page table and a translation lookaside buffer.

16. The apparatus of claim 13, wherein the cache controller is to flush at least one dirty line in the cache prior to decreasing a size of the cache and modify at least one of a page table and a translation lookaside buffer in response to decreasing the size of the cache, wherein the at least one dirty line in the cache includes data that has been changed since a last write back to the second memory.

17. The apparatus of claim 11, wherein the cache controller is to configure a table to associate at least one physical address range of the cache in the first memory with at least one physical address range in the second memory that includes information for caching in the cache.

18. The apparatus of claim 17, wherein the cache controller is to configure the table to include at least one parameter to define the cache, the at least one parameter comprising at least one of information indicating a starting physical address of the cache, a number of sets or ways in the cache, a line size in the cache, a replacement policy for the cache, and an error correcting code for a cache line in the cache.

19. The apparatus of claim 11, wherein the cache controller is to configure a plurality of logical caches associated with a plurality of physical address ranges in the second memory.

20. The apparatus of claim 11, wherein the indicator of locality comprises an indicator of at least one of temporal locality and spatial locality.

21. A non-transitory computer readable storage medium embodying a set of executable instructions, the set of executable instructions to manipulate a computer system to perform a portion of a process to fabricate at least part of a processor, the processor comprising:
a cache controller to configure a portion of a first memory as cache for a second memory dependent upon an indicator of locality of memory access requests to the second memory, wherein the indicator of locality determines a probability that a location of a memory access request to the second memory is predictable based upon at least one previous memory access request.

22. The non-transitory computer readable storage medium of claim 21, wherein the cache controller is further configured to:
determine a size of the cache dependent upon a value of the indicator of locality; and
modify the size of the cache in response to changes in the value of the indicator of locality.
